(19) United States
(12) Patent Application Publication
(10) Pub. No.: US 2013/0117708 A1
(43) Pub. Date: May 9, 2013

(54) SCROLL METHOD AND APPARATUS OF USER DEVICE

(71) Applicant: Samsung Electronics Co., Ltd., Gyeonggi-do (KR)

(72) Inventor: Sangjin LEE, Seoul (KR)

(73) Assignee: Samsung Electronics Co., Ltd., Gyeonggi-do (KR)

(21) Appl. No.: 13/668,942

(22) Filed: Nov. 5, 2012

(30) Foreign Application Priority Data
Nov. 4, 2011 (KR) 10-2011-0114226

(51) Int. Cl. G06F 3/048

(52) U.S. Cl. 715/786

(57) ABSTRACT

A scroll method and apparatus is provided for scrolling is provided. The scroll method includes extracting, when a request to display a scroll object is detected, the scroll object; drawing an entire region corresponding to the entire scroll object into a frame buffer; and presenting, on a screen of the user device, only a part of the drawn region corresponding to the detected request.

### PRIORITY

This application claims priority under 35 U.S.C. §119(a) to Korean Patent Application No. 10-2011-0114226, which was filed in the Korean Intellectual Property Office on Nov. 4, 2011, the entire contents of which are incorporated herein by reference.

### BACKGROUND OF THE INVENTION

1. Field of the Invention

The present invention relates to generally a method and apparatus for scrolling in a user device and, more particularly, to a method and apparatus for directly scrolling an object larger than a screen in size promptly and seamlessly in response to the scroll event triggered by the user.

2. Description of the Related Art

With the advance of digital technologies, various user mobile devices supporting communication and information processing have been commercialized in the form of devices such as portable terminal, Personal Digital Assistants (PDAs), electronic organizers, smartphones, tablet Personal Computers (PCs), etc. Such user devices have features such as video calling, electronic organizer, video capture, email, broadcast playback, Internet access, music file playback, schedule manager, Social Network Service (SNS), messenger, dictionary, game, etc.

Such user devices are configured to provide execution screens related to various functions, and these devices may display various menu and list screens having a scroll object (i.e., an object to be scrolled) scrollable thereon. The scroll object, which is larger than a size of the screen of the user device, is scrolled on the screen in response to a scroll event triggered by the user. A conventional scroll operation is described as follows.

FIG. 1 is a diagram illustrating a scrolling operation of a conventional user device.

In FIG. 1, a user device includes a display unit 10 and a scroll object 20 Reference number 30 denotes a part of the scroll object 20 that is hidden according to a scroll event triggered by the user, reference number 40 denotes a part of the scroll object 20 that is reused according to the scroll event triggered by the user, and reference number 50 denotes another part of the scroll object 20 that is redrawn according to the scroll event triggered by the user.

Referring to FIG. 1, the user may provide an input for scrolling the scroll object 20 displayed on the screen of the display unit 10 via a pointing device (e.g. via a physical key corresponding to a scroll function or via a touch screen interface). The user device scrolls the scroll object 20 displayed on the screen of the display unit 10 in response to the user input made via the pointing device. For example, in FIG. 1, the scroll object 30 is scrolled left by a distance corresponding to the distance of the scroll gesture.

In order to update the screen in response to the user input, the user device must perform redrawing process in the frame buffer of the display unit 10 for rendering the newly appearing part 50 of the scroll object 20. For example, if the scroll object 20 is scrolled left in response to the scroll input, the left part 30 of the scroll object 20 is pushed out of the screen to the left. That is, the left part 30 of the scroll object 20 disappears from the screen. The area where the left part 30 has disappeared is filled with the reuse part 40, and the hidden part 50 of the scroll object 20 is pulled into the screen. At this time, the hidden part 50 of the scroll object is drawn in the frame buffer and delivered to the display unit 10 such that the screen is refreshed.

As described above, in the conventional scroll method, the user device must perform the frame buffer drawing operation repeatedly whenever the screen displaying the scroll object is refreshed in response to the scroll event triggered by the user. This means that the conventional scroll method causes redundant repetition of buffer copy operation (e.g. copying the part of the scroll object, which is requested to be drawn, from the storage to the frame buffer) in order to refresh the screen. Such a scroll method increases the processing load of the system (e.g. with respect to a controller such as Central Processing Unit (CPU) or a Graphical Processing Unit (GPU) of the user device), results in a delay of screen refreshes.

In the conventional scroll method, the user device must perform the screen refresh whenever a scroll event triggered by the user. In the conventional scroll method, the old video data must be moved while new video data replaces the old data in the frame buffer of the display unit 10 to refresh the screen, resulting in an increase of a data processing load of the system. The system load further increases as the complexity of the scroll object increases. The increased system load causes degradation of the system performance, resulting in scroll operation delays.

### SUMMARY OF THE INVENTION

The present invention has been made in an effort to address the above-described problems, and to provide a scroll method and apparatus of a user device that is capable of scrolling of the object on the screen in response to the scroll event.

According to an aspect of the present invention, a scroll method and apparatus of a user device that is capable of reducing redundant data movement and redrawing in the frame buffer to facilitate the scroll operation without delay are provided.

According to another aspect of the present invention, a scroll method and apparatus of a user device that is capable of refreshing the screen quickly and seamlessly by drawing the entire region of the scroll object into the frame buffer at the stage of generating scroll object initially and updating only the buffer information for the scroll object in the frame buffer are provided.

According to another aspect of the present invention, a scroll method and apparatus of a user device that is capable of drawing the entire region of the scroll object in the frame buffer by allocating the frame buffer size dynamically according to the size of the entire scroll object are provided.

It is still another object of the present invention to provide a scroll method and apparatus of a user device that is capable of presenting the part scrolled in response to a scroll event quickly and seamlessly, within the entire region of the scroll object drawn in a frame buffer.

In accordance with an aspect of the present invention, a scroll method of a user device is provided. The method includes extracting, when a request to display a scroll object is detected, the scroll object; drawing an entire region corresponding to the entire scroll object into a frame buffer; and presenting, on a screen of the user device, only a part of the drawn region corresponding to the detected request.

In accordance with another aspect of the present invention, a scroll method of a user device is provided. The method includes detecting a scroll event triggered by a user in state where a part of an entire region corresponding to an entire scroll object drawn in a frame buffer is presented on a screen; checking buffer information in response to the detected scroll event; computing a new part of the drawn region to be presented on the screen according to an update of the buffer information of the frame buffer; and refreshing the screen with the new part of the drawn region.

In accordance with another aspect of the present invention, a computer-readable recording medium, on which a program for executing the method in a processor is recorded, is provided.

In accordance with still another aspect of the present invention, a user device is provided. The user device includes a storage unit for storing a scroll object; a display unit for displaying a screen presenting the scroll object drawn in the frame buffer and refreshed with an update according to the scroll of the scroll object; a control unit for controlling extracting, when a request to display the scroll object is detected, the scroll object, drawing entire region of the scroll object into a frame buffer, and presenting, on the screen, a part of the drawn entire region corresponding to the request; and the frame buffer for storing the drawn entire region of the scroll object.

The foregoing broadly outlines certain features and technical advantages of the present invention in order that the detailed description of the invention that follows may be better understood. Additional features and advantages of the invention are described hereinafter.

### BRIEF DESCRIPTION OF THE DRAWINGS

The above and other aspects, features and advantages of the present invention will be more apparent from the following detailed description taken in conjunction with the accompanying drawings, in which:

FIG. 1 is a diagram illustrating a scrolling operation of a conventional user device;

FIG. 2 is a block diagram illustrating a configuration of the user device according to an embodiment of the present invention;

FIGS. 3 and 4 are diagrams illustrating scroll operation of the user device according to an embodiment of the present invention;

FIG. 5 is a flowchart illustrating a scroll method of a user device according to an embodiment of the present invention;

FIG. 6 is a flowchart illustrating a procedure for controlling the scroll operation in the user device according to an embodiment of the present invention; and

FIGS. 7 and 8 are diagrams illustrating scroll operations with and without application of the direct scroll method according to an embodiment of the present invention.

### DETAILED DESCRIPTION OF EMBODIMENTS OF THE PRESENT INVENTION

Embodiments of the present invention are described in detail as follows with reference to the accompanying drawings. The same reference numbers are used throughout the drawings to refer to the same or like parts. Detailed description of well-known functions and structures incorporated herein may be omitted to avoid obscuring the subject matter of the present invention.

According to an embodiment of the present invention, a direct scrolling method and apparatus of a user device are provided. The direct scrolling method and apparatus is capable of negating the movement and redrawing of the data performed in response to every scroll event, resulting in a fast and seamless scroll operation. The scroll method and apparatus is also capable of displaying a scroll object larger than a screen of the user device efficiently through a seamless scrolling operation.

According to an embodiment of the present invention, a scroll method and apparatus determine the size of a frame buffer of a display unit dynamically according to the entire size of the scroll object in an initial stage of creating the scroll object such that the entire scroll region can be buffered. Therefore, the entire region of the scroll object is drawn in the frame buffer at one time. This scroll method and apparatus is capable of calculating an area to be changed in the entire region of the scroll object and presenting the change on the screen in response to a scroll event triggered by the user without redrawing the scroll object.

This apparatus and method removes the requirement to repeatedly perform the redrawing process whenever it is necessary to refresh a screen (such as a menu screen and a list screen) in response to a scroll command input by the user, and accordingly, system load is reduced. According to the apparatus and method, the redrawing operation in the frame buffer for screen refresh with new area when the user scrolls the scroll object on the screen especially by means of a pointing device. By removing the redrawing operation from the scroll process, the method and apparatus reduce the system load, resulting in fast and seamless scroll operations.

The structure of the user device and control method thereof according to an embodiment of the present invention are described as follows with reference to the accompanying drawings. However, embodiments of the present invention is not limited to the described configuration and control method of the user device, but can be implemented with various modifications in other embodiments.

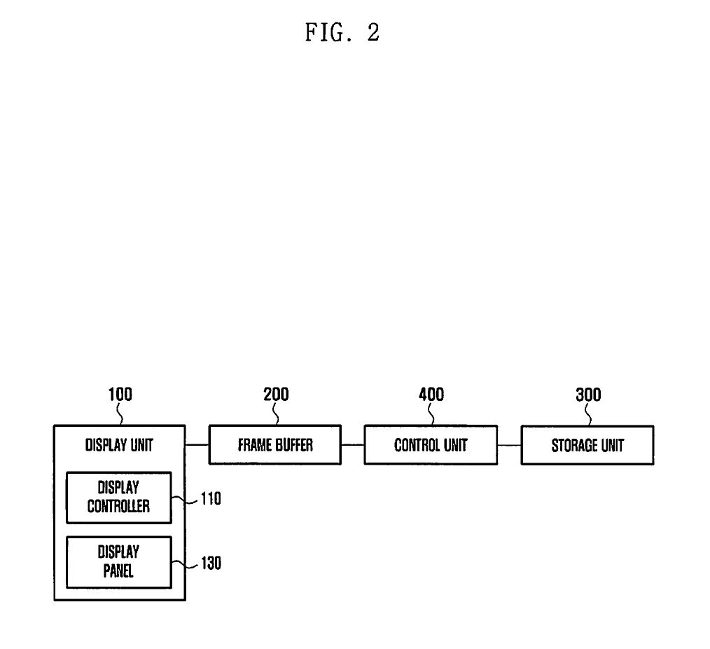

FIG. 2 is a block diagram illustrating a configuration of the user device according to an embodiment of the present invention.

As shown in FIG. 2, the user device according to an embodiment of the present invention includes a display unit 100, a frame buffer 200, a storage unit 200, and a control unit 400. Although not depicted in FIG. 2, the user device may further include an audio processing unit having a microphone and a speaker, a digital broadcast module for receiving digital broadcast signal such as Digital Multimedia Broadcasting (DMB) and Digital Video Broadcast (DVB) signals, a camera module for capturing still and motion pictures of an object, a short range communication module including a least one of Bluetooth, Infrared Data Association (IrDA), Radio Frequency Identification (RFID), and Near Field Communication (NFC), an input unit, a pointing device such as touch screen for receiving touch input, a Radio Frequency (RF) module for supporting cellular-based voice, video, and data communication, a communication module for supporting IP-based internet communication service, and battery for supplying power to the aforementioned components.

The display unit 100 displays the screens related to the operation status of the user device. For example, the display unit 100 may display a menu screen having menu items of the user device and execution screens corresponding to various applications. The display unit 100 may be any of a Liquid Crystal Display (LCD), Light Emitting Diode (LED), Organic LED (OLED), and Active Matrix OLED (AMOLED). The display unit 100 may also include a display controller 110 and a display panel 130.

According to an alternate embodiment of the present invention, the display controller 110 included in the display unit 100 may include the frame buffer 200, such that the display controller 110 temporarily draws an entire region of a scroll object received from the control unit 400 and transfers a part of the scroll object to be output to the display panel 130, and the display panel 130 displays this part of the scroll object on the screen. The display controller 110 may update the current buffer information of the frame buffer 200 under the control of the control unit 400. The display controller 110 transfers a specific part of the scroll object to the display panel 130 according to updated buffer information from the entire region of the scroll object drawn in the frame buffer 200 so as to output the updated information on the screen.

According to an embodiment of the present invention, the display unit 100 may be provided with a touch input interface. For example, the display unit 100 may be implemented with a touch screen so as to detect a touch gesture and generate an input signal corresponding to the touch gesture to be provided to the control unit 400. According to an embodiment of the present invention, the display unit 100 may refresh the screen displaying the scroll object dynamically according to the scroll of the object on the screen in response to a scroll event triggered by the user.

The frame buffer 200 temporarily stores the screen data (e.g., a scroll object) to be displayed through the display unit 100. The frame buffer copies the screen data from the storage unit 300 to the display unit 100 under the control of the control unit 400. According to an embodiment of the present invention, the frame buffer 200 may draw the entire region of the screen data when the screen data (scroll object) is initially created to be displayed through the display unit 100. As described herein, the frame buffer 200 may be included in the display unit 100 (more specifically, included within the display controller 110). As an alternative, the frame buffer 200 also may be included in the control unit 400. A process for drawing the scroll object in the frame buffer 200 is described in further detail herein.

The storage unit 300 stores various applications and data executed and processed by the user device and includes at least one of volatile and non-volatile memories. That is, the storage unit 300 may include at least one of Read Only Memory (ROM), flash memory, Random Access memory (RAM), internal and external hard discs, and other external storage media. The storage unit 300 persistently and/or temporarily stores the Operating System (OS) of the user device, programs and data associated with the display operation of the display unit 100, programs and data associated with input control operation through the display unit 100, programs and data associated with the function execution of the user device, and programs and data associated with the scroll function execution of the user device. According to an embodiment of the present invention, the storage unit 300 stores the screen data (scroll object) presented on the screen of the display unit 100 and transfers the stored screen data to the frame buffer 200 under the control of the control unit 400.

The control unit 400 controls overall operations of the user device. More specifically, the control unit 400 controls the operation associated with the direct scroll function proposed in the present invention. The control unit 400 controls the direct scrolling operation without requiring movement and redrawing in the frame buffer.

For example, when the scroll object is created to be displayed on the screen, the control unit 400 dynamically determines the size of the frame buffer 200 according to the size of the entire of the scroll object, in order to draw the entire region of the scroll object in the frame buffer 200. If a scroll event triggered by a pointing device (e.g., a physical key designated for scroll function, mouse, a touch screen, etc.), the control unit 400 controls operations for displaying a specific region of the control object stored in the frame buffer 200 on the display unit 100.

When the scroll object to be displayed on the screen is created in response to the user request, the control unit 400 adjusts the size of the frame buffer of the display unit 100 according to the size of the entire scroll object such that the scroll object can be buffered. The control unit 400 draws the entire scroll object in the frame buffer adjusted to fit the size of the entire scroll object all at one time. When the scroll object is scrolled in response to the scroll event triggered by the user, the control unit 400 extracts a part changed in the entire region of the scroll object drawn according to the buffer information update in the frame buffer 200 without redrawing the scroll object and updates the screen output of the display unit 100 with the extracted part.

As described above, the control unit 400 controls the overall operations associated with the scroll method according to an embodiment of the present invention. Control operations of the control unit 400 in the user device operation example and control method are described in further detail herein with reference to accompanying drawings.

The control unit 400 controls various operations associated with general functions of the user devices. For example, when a specific application is executed, the control unit 400 controls the application execution and display of the execution screen. The control unit 400 also receives an input signal corresponding to the touch event detected on the touch input interface and controls the function execution according to the input signal. The control unit 400 also controls data communication through wired and/or wireless links.

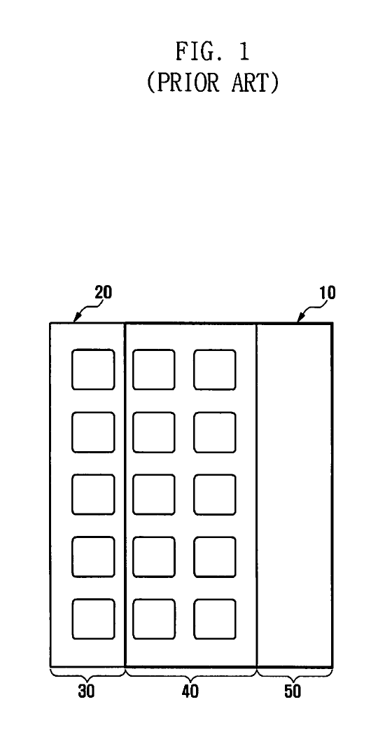

The user device configured as shown in FIG. 1 may be any of a variety of information communication devices, multimedia devices, and other equivalent application devices. For example, the user device may be any mobile terminal operating based on the respective communication protocols, a tablet Personal Computer (PC), a smartphone, a digital camera, a Portable multimedia Player (PMP), a media player, a portable game console, laptop computer, a Personal Digital Assistant (PDA), etc. Furthermore, the scroll method according to an embodiment of the present invention may be applied to various display-enabled devices, such as a Digital TV, Digital Signage (DS), a Large Format Display (LFD), and a laptop computer.

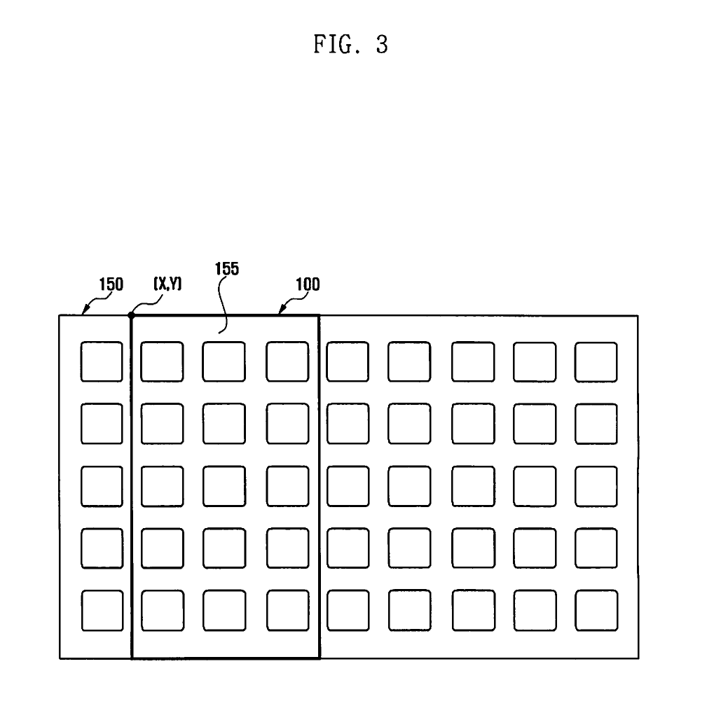

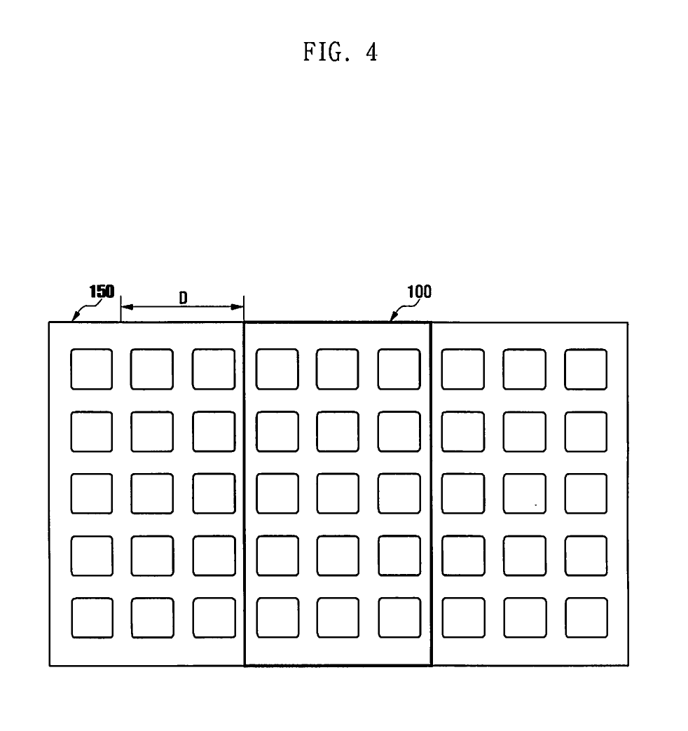

FIGS. 3 and 4 are diagrams illustrating scroll operation of the user device according to an embodiment of the present invention.

In FIGS. 3 and 4, reference number 100 denotes the display unit of the user device, and reference number 150 denotes the entire region of the scroll object.

Referring to FIGS. 3 and 4, when creating the scroll object in response to the user request, the user device extracts, from the storage unit 300, the entire region 150 of the scroll object rather than just a part (to be presented on the current screen as denoted by reference number 155) of the scroll object.

The user device draws the entire region 150 of the scroll object, which is extracted from the storage unit 300, into the frame buffer 200 and displays the requested part 155 of the entire region 150 of the scroll object on the screen of the display unit 100. According to an embodiment of the present invention, the user device calculates the size of the entire region 150 of the scroll object, adjusts the size of the frame buffer 200 to match the calculated size of the entire region 150, and draws the entire region 150 of the scroll object into the frame buffer 200.

When the requested part 155 of the entire region 150 of the scroll object drawn in the frame buffer, the user may trigger a scroll event for scrolling the scroll object through a pointing device (e.g., a physical key designated for a scroll function or a mouse, a touch screen, etc.). In response to the scroll event, the user device scrolls the scroll object of which the part 155 is displayed on the screen of the display unit 100. For example, the scroll object may be scrolled to the left as much as a distance (D) corresponding to the scroll event as shown in FIGS. 3 and 4.

At this time, the user device checks the distance (D) corresponding to the scroll event and computes the part of the scroll object corresponding to the distance. The part corresponding to the scroll event may be computed by the following Equations (1) and (2):

new X offset=X offset+dx (1)

new Y offset=Y offset+dy, (2),

where the X offset and Y offset denote the start coordinates (X, Y) of the part presented on the current screen on the X and Y axes as shown in FIG. 3. The values dx and dy are the X and Y axes movement distances corresponding to the part of the scroll object in response to the scroll event as shown in FIG. 4. That is, dx and dy are the respective x and y axes movement values of the scroll event made by the pointing device. In the example of FIGS. 3 and 4, there is no y-axis movement, and thus the movement distance on y-axis is 0. New X offset and new Y offset denote the new coordinates as a result of the scroll on the X and Y axes in response to the scroll event.

As shown in Equations (1) and (2), the new part of the scroll object moved onto the screen in response to the scroll event is determined by adding the X-axis movement value (dx) and Y axis movement value (dy) to the respective X-axis and Y-axis reference point of (X, Y), i.e., the current buffer information of the frame buffer 200 may be updated by configuring as much as the distance scrolled according to the scroll event.

The user device displays the computed part of the entire region 150 of the scroll object on the screen of the display unit 100. If a scroll event takes place, the user device controls the presentation on the screen by updating the current buffer information of the frame buffer 200 (e.g. updating coordinates (X, Y) before reflecting dx and dy to new coordinates (new X, new Y) obtained by reflecting dx and dy). Details of this operation are described later herein. Since embodiments of the present invention negate the need of redrawing in scrolling a scroll object so as to reduce system load, resulting in seamless scroll operation on the screen.

Although the above-described example is directed to scrolling an object elongated in a horizontal direction relative to a screen, embodiments of the present invention can also be applied to a scroll object elongated in vertical direction or elongated in both horizontal and vertical directions. More specifically, the scroll event may trigger the scroll of the object in vertical and/or horizontal directions, thereby changing the X and/or Y values.

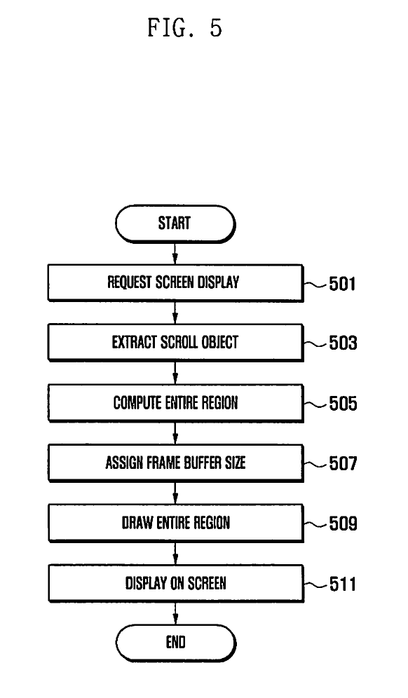

FIG. 5 is a flowchart illustrating a scroll method of a user device according to an embodiment of the present invention.

Referring to FIG. 5, the control unit 400 of the user device detects a request to display a scroll object on the screen at step 501. Upon detecting the request, the control unit 400 extracts the corresponding scroll object at step 503. The user provides a user input to request display of a menu screen through the pointing device (e.g., a physical key or touch screen) of the user device. The control unit 400 checks the menu screen requested by the user and extracts the corresponding scroll object from the storage unit 300. When extracting the scroll object to be displayed, the control unit 400 extracts not only the specific part of the scroll object to be currently displayed on the screen, but extracts the entire region of the scroll object including the part of the scroll object to be currently presented on the screen.

Next, the control unit 400 computes the entire region of the extracted scroll object at step 505. The control unit 400 adjusts the size of the frame buffer 200 to match with the size of the entire region of the scroll object at step 507. When displaying the screen in response to the user request, the control unit 400 adjusts the size of the frame buffer 200 dynamically to match the entire size of the scroll object.

The control unit 400 draws the entire region of the scroll object in the frame buffer 200 at step 509. The control unit 400 transfers a part of the scroll object drawn in the frame buffer 200 so as to be presented on the screen of the display unit 100 at step 511.

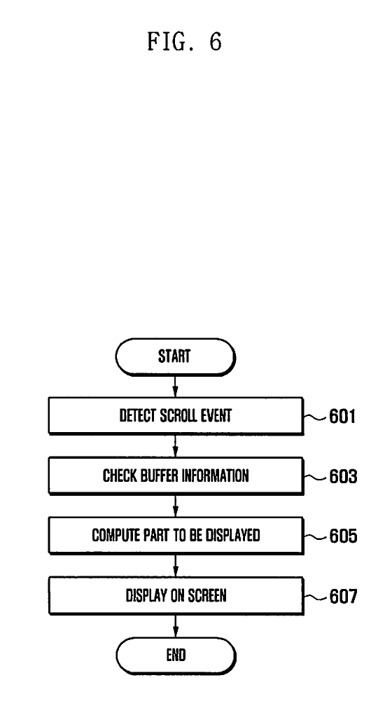

FIG. 6 is a flowchart illustrating a procedure for controlling the scroll operation in the user device according to an embodiment of the present invention.

In the example according to FIG. 6, the entire region of the scroll object is drawn in the frame buffer 200 and a specific part of the scroll object is displayed on the screen of the display unit 100, such as shown in FIGS. 3 and 4 and described with reference to FIG. 5.

The control unit 400 of the user device detects a scroll event triggered by the user in the state where the specific part of the entire region of the scroll object drawn in the frame buffer 200 is displayed, at step 601. If the user triggers the scroll event for scrolling the scroll object through the pointing device, the pointing device generates an input signal corresponding to the scroll event to the control unit 400. The control unit 400 detects the scroll event corresponding to the receipt of the input signal sent by the pointing device.

If the scroll event is detected, the control unit 40 checks the current buffer information (e.g. coordinates) of the frame buffer 200, at step 603. The control unit 400 computes a new part of the scroll object to be displayed on the screen of the display 100 based on the current buffer information of the frame buffer 200 and the movement distance of the scroll event at step 605. At this time, the control unit 400 computes the new part of the scroll object to be displayed on the screen of the display unit 100 by applying the part of the updated buffer information to the current buffer information of the entire region of the scroll object drawn in the frame buffer 200. The updated buffer information represents the coordinates (new X, new Y) updated by applying the distance scrolled according to the scroll event. The control unit 400 may control the display of the newly calculated presentation part on the screen at step 607.

In order to control scrolling of the object in response to the scroll event, the control unit 400 checks the distance (D) (or coordinates) of the scroll made in response of the scroll event within the entire region of the scroll object and computes the part to be displayed on the screen of the display unit 100 based on the checked distance (D) (or coordinates) to determine a new presentation part. The new presentation part may be computed as described with reference to Equations (1) and (2). The control unit 400 updates the display of the screen based on the updated buffer information of the frame buffer 200 by applying the scroll distance to the current buffer information of the frame buffer other than updating the frame buffer 200 with new scroll object according to the scroll event. The control unit 400 controls the screen display by matching the coordinates (new X, new Y) obtained through the buffer information update with the screen display start coordinates (0, 0).

When controlling scrolling of the object drawn in the frame buffer 200, the control unit 400 instructs the display controller 110 of the display unit 100 to control the screen display based on the computed buffer information as described above. The display controller 110 updates the buffer information of the frame buffer 200 and transfers the specific part of the scroll object to be displayed on the screen under the control of the control unit 400.

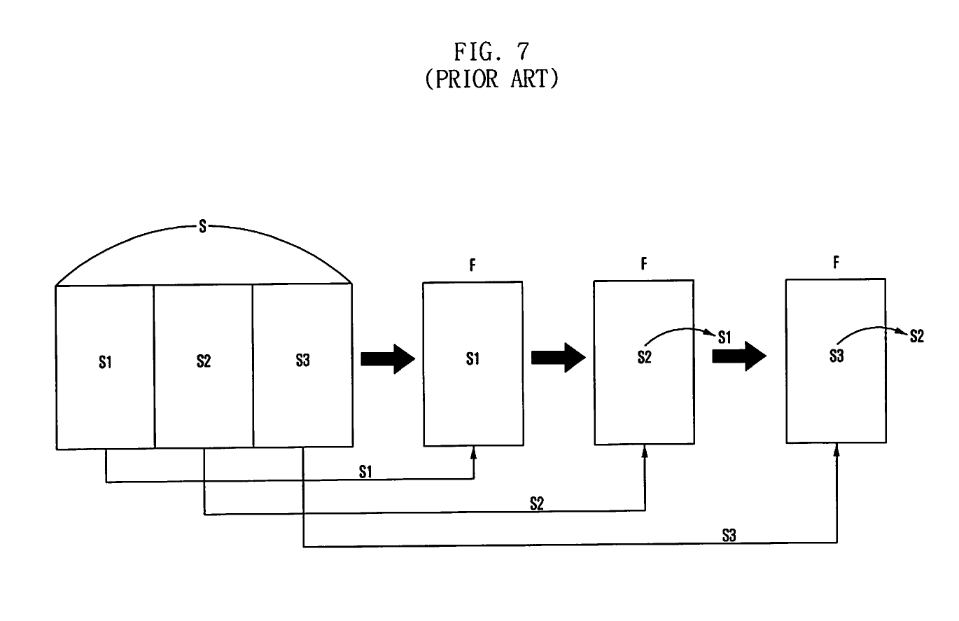

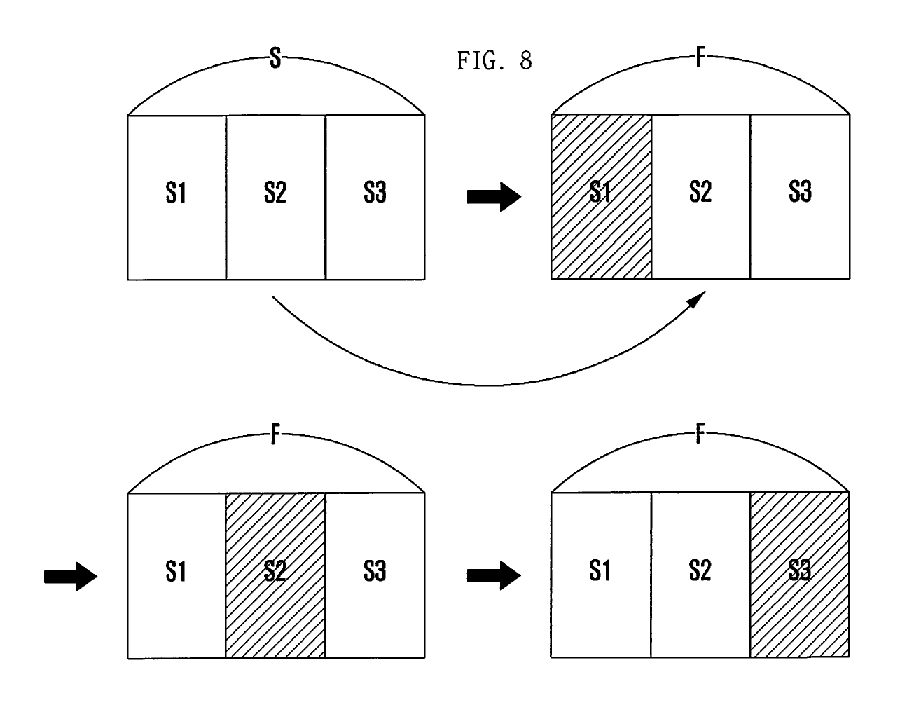

FIGS. 7 and 8 are diagrams illustrating scroll operations with and without application of the direct scroll method according to an embodiment of the present invention.

FIG. 7 shows a procedure for drawing a scroll object S into a frame buffer F in the conventional scroll method, and FIG. 8 shows a procedure for drawing a scroll object S into a frame buffer F in the scroll method according to an embodiment of the present invention.

In FIGS. 7 and 8, the scroll object S is divided into part S1, part S2, and part S3. In the divided scroll object, the part S1 is initially displayed on the screen in response to a user request and then the three parts of the scroll object are scrolled in response to a scroll event triggered by the user (e.g. in order of part S1→part S2→part S3).

Although not depicted in FIGS. 7 and 8, there is a part reused in scroll operation, but detailed description on the reused part is omitted herein. In this case, the operations depicted in FIGS. 7 and 8 may be understood as the cases of scrolling an object composed of multiple pages.

In the examples according to FIGS. 7 and 8, scrolling is performed with each page block, and a new page scrolled without a reused part of the previous page is displayed, when the scrolling is performed in response to the scroll event.

Referring to FIG. 7, if the user requests displays of part S1 of the scroll object S, part S1 is drawn in the frame buffer F (first drawing). The part S1 drawn in the frame buffer F is transferred to the display unit 100 so as to be displayed on the screen.

If a scroll event is triggered by the user requesting display of part S2 in the state where the part S1 is displayed on the screen, the part S1 drawn in the frame buffer F is removed and then the part S2 is drawn in the frame buffer (second drawing). The part S2 drawn in the frame buffer F is sent to the display unit 100 such that the screen is updated with the part S2.

If a scroll event is triggered by the user requesting display of part S3 in the state where the part S2 is displayed on the screen, the part S2 drawn in the frame buffer F is removed and then the part S3 is drawn in the frame buffer (third drawing). The part S3 drawn in the frame buffer F is sent to the display unit 100 such that the screen is updated with the part S3.

In this way, the conventional scroll method repeats the shift and redrawing of the scroll object in the frame buffer F whenever the scroll even is triggered (e.g. 3 times of drawing in the above example). Such repeated shift and drawing operations increase the system load, and the problem goes worse as the complexity of the scroll object increases. As a consequence, the increased system load causes a screen refresh delay, resulting in failure of seamless scrolling.

In the scroll method according to an embodiment of the present invention, however, if the user requests to display part S1 of the divided scroll object S including parts S1, part S2, and part S3, the entire region of the scroll object S, including parts S1, S2, and S3, is drawn in the frame buffer F, as shown in FIG. 8. At this time, the frame buffer size is adjusted to fit with the size of the entire region of the scroll object. The part S1 requested by the user within the entire region drawn in the frame buffer F is sent to the display unit 100 and is displayed on the screen.

If a scroll event is triggered by the user to request display of part S2, in a state where the part S1 is currently displayed on the screen, the screen display start coordinates are updated with the scroll distance value (D) (or coordinates, i.e., the start coordinates of part S2) on the entire region of the scroll object S drawn in the frame buffer F in response to the scroll event such that the screen is updated to display the part S2.

If a scroll event is triggered by the user to display the part S3 in the state where the part S2 is displayed on the screen, the screen display start coordinates are updated with the scroll distance value (D) (or coordinates, i.e., the start coordinates of the part S2) on the entire region of the scroll object S drawn in the frame buffer F in response to the scroll event such that the screen is updated to display the part S3.

In this way, the scroll method of the present invention draws the entire region of the scroll object S in the frame buffer F at a time when the scroll object is created initially and refreshes the screen only according to an update of the buffer information according to the scroll operation in response to the scroll event generated with respect to the entire region of scroll object. This process according to an embodiment of the present invention negates the need for the redrawing operation to be performed whenever the scroll event is triggered so as to reduce the system load as compared to the conventional scroll method, resulting in seamless scroll of object on the screen.

The above-described direct scrolling method of a user device according to an embodiment of the present invention can be implemented in the form of computer-executable program commands and stored in a computer-readable storage medium. The computer readable storage medium may store the program commands, data files, and data structures in individual or combined forms. The program commands recorded in the storage medium are designed and implemented for various embodiments of the present invention.

A computer-readable storage medium according to embodiments of the present invention may include magnetic media such as a floppy disk and a magnetic tape, optical media including a Compact Disc (CD) Read Only Memory (ROM) and a Digital Video Disc (DVD) ROM, a magneto-optical media such as an floptical disk, and/or a hardware device designed for storing and executing program commands such as ROM, Random Access Memory (RAM), and flash memory. The programs commands include the language code executable by computers using the interpreter as well as the machine language codes created by a compiler. The aforementioned hardware devices can be implemented with one or more software modules for executing the operations of various embodiments of the present invention.

As described above, the scroll method and apparatus of a user device according to embodiments of the present invention draws an entire region of a scroll object into the frame buffer at one time when the scroll object is initially created and refreshes the screen based on the information on a change within the entire region of the scroll object. The scroll method and apparatus according to embodiments of the present invention computes the entire size of the scroll object when the scroll object is created and adjusts the size of the frame buffer according to the entire size of the scroll object.

The scroll method and apparatus according to embodiments of the present invention removes the necessity of performing the repetitive drawing operations in response to scroll events, so as to reduce a system load, resulting in seamless scrolling of the object on the screen. The scroll method and apparatus also removes the necessity of updating the scroll object occurring in the frame buffer whenever a scroll event is triggered, thereby reducing the amount of operations required to support the scroll function, resulting in simplification of scroll computation complexity (e.g. software structure).

Embodiments of the present invention can be applied to various types of user devices described herein, as well as their equivalents. The scroll method and apparatus is advantageous in that they optimize the scrolling operation environment and improve utilization, convenience, and competitiveness of user devices.

While the invention has been shown and described with reference to certain embodiments thereof, it will be understood by those skilled in the art that various changes in form and details may be made therein without departing from the spirit and scope of the present invention as defined by the appended claims and their equivalents.

What is claimed is:

1. A scroll method of a user device, comprising:
extracting, when a request to display a scroll object is detected, the scroll object;
drawing an entire region corresponding to the entire scroll object into a frame buffer; and
presenting, on a screen of the user device, only a part of the drawn region corresponding to the detected request.

2. The scroll method of claim 1, further comprising:
detecting a scroll event triggered by a user in state where the part of the drawn region is displayed on the screen,
checking current buffer information of the frame buffer;
computing a new part of the drawn region to be presented on the screen as a result of updating the frame buffer with the current buffer information; and
refreshing the screen with the new part of the scroll object.

3. The scroll method of claim 2, wherein computing the new part of the drawn region comprises calculating the new part of the drawn region based on the current buffer information of the frame buffer and buffer information updated with scroll distance of the scroll event.

4. The scroll method of claim 3, wherein calculating the new part of the drawn region comprises:
checking, when scrolling the scroll object in response to the scroll event, the scroll distance or coordinates in accordance with the scroll event; and
determining the new part to be presented on the screen based on the scroll distance or coordinates.

5. The scroll method of claim 4, wherein calculating the new part of the drawn region comprises determining the new part of the drawn region according to:
new X offset=X offset+dx
new Y offset=Y offset+dy,
which adds scroll distance dx on an X-axis and scroll distance dy on a Y-axis to X and Y axes values of the currently presented part,
wherein the X offset and Y offset denote start coordinates (X, Y) of the part presented on the current screen on X and Y axes, dx and dy are X and Y axes movement distances of the part of the scroll object in response to the scroll event, and new X offset and new Y offset denote new coordinates as a result of scrolling on the X and Y axes in response to the scroll event.

6. The scroll method of claim 2, wherein drawing the entire region comprises:
extracting the scroll object from a storage;
computing the entire region of the extracted scroll object;
adjusting a size of the frame buffer to fit within a size of the entire region; and
drawing the entire region of the scroll object into the frame buffer.

7. A scroll method of a user device, comprising:
detecting a scroll event triggered by a user in state where a part of an entire region corresponding to an entire scroll object drawn in a frame buffer is presented on a screen;
checking buffer information in response to the detected scroll event;
computing a new part of the drawn region to be presented on the screen according to an update of the buffer information of the frame buffer; and
refreshing the screen with the new part of the drawn region.

8. The scroll method of claim 7, wherein detecting the scroll event comprises:
drawing the entire region of the scroll object into the frame buffer;
presenting a part of the entire region drawn in the frame buffer; and
detecting the scroll event in state where the part of the scroll object is presented on the screen.

9. The scroll method of claim 7, wherein computing the new part comprises calculating the new part based on current buffer information of the frame buffer and buffer information updated with a scroll distance of the scroll event.

10. The scroll method of claim 9, wherein calculating the new part comprises:
checking, when scrolling the scroll object in response to the scroll event, the scroll distance or coordinates in accordance with the scroll event; and
determining the new part to be presented on the screen based on the scroll distance or coordinates.

11. The scroll method of claim 10, wherein calculating the new part comprises determining the new part to be presented on the screen by adding a scroll distance on an X-axis and a scroll distance on a Y-axis to X and Y axes values of the currently-presented part of the entire region.

12. A user device comprising:
a storage unit for storing a scroll object;
a display unit for displaying a screen presenting the scroll object drawn in the frame buffer and refreshed with an update according to the scroll of the scroll object; a control unit for controlling extracting, when a request to display the scroll object is detected, the scroll object, drawing entire region of the scroll object into a frame buffer, and presenting, on the screen, a part of the drawn entire region corresponding to the request; and
the frame buffer for storing the drawn entire region of the scroll object.

13. The user device of claim 12, wherein the display unit comprises:
a display controller that draws the entire region of the scroll object provided by the control unit into the frame buffer; and
a display panel that presents the part of the scroll object transferred by the display controller on the screen.

14. The user device of claim 13, wherein the display controller updates the current buffer information of the frame buffer under the control of the control unit and transfers the part of the scroll object that is determined according to the updated buffer information to the display panel to display the part on the screen.

15. The user device of claim 13, wherein the control unit checks, when a scroll event is detected, current buffer information of the frame buffer, computes the new part to be presented on the screen as a result of updating the frame buffer with the current buffer information, and refreshes the screen with the new part of the scroll object.

16. The user device of claim 15, wherein the control unit calculates the new part based on the current buffer information of the frame buffer and buffer information updated with a scroll distance of the scroll event.

17. The user device of claim 15, wherein the control unit checks, when scrolling the scroll object in response to the scroll event, a scroll distance or coordinates in accordance with the scroll event, and determines the new part to be presented on the screen based on the scroll distance or coordinates.

18. The user device of claim 17, wherein the control unit determines the new part to be presented on the screen by adding a first scroll distance on an X-axis and a second scroll distance on Y-axis to X and Y axes values of the part of the scroll object currently presented.

19. The user device of claim 15, wherein, the control unit computes the entire region of the scroll object extracted from the storage unit, assigns a size of frame buffer matching with the size of the entire region of the scroll object, and draws the entire region of the scroll object into the frame buffer.
